(19) United States
(12) Patent Application Publication
(10) Pub. No.: US 2006/0198734 A1
(43) Pub. Date: Sep. 7, 2006

(54) Manufacturing method for obtaining high-temperature components for gas turbines and components thus obtained

(76) Inventors: Alessandro Coppola, Prato (IT); Marco Innocenti, Pistoia (IT)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/539,198

(22) PCT Filed: Dec. 10, 2003
(86) PCT No.: PCT/EP03/14176

§ 371 Date: May 9, 2006

(30) Foreign Application Priority Data
Dec. 18, 2002 (IT) MI2002A002677

(51) Int. Cl. F03B 3/12

(52) U.S. Cl. 416/241 R

(57) ABSTRACT

A manufacturing method for obtaining high-temperature components (10) for gas turbines, which comprises at least incorporation of an element or insert (14) in a main body (12) of the component (10), this element or insert (14) having mechanical properties able to withstand stresses to which said component (10) is subject in a zone where the said element or insert (14) is arranged; the invention also relates to a high temperature component thus obtained.

The present invention relates to a manufacturing method for obtaining high-temperature components for gas turbines.

The invention also relates to these high-temperature components thus obtained.

As is known, gas turbines are machines consisting of a compressor and a single or multiple-stage turbine, where these components are connected together by a rotating shaft and where a combustion chamber is provided between the compressor and the turbine.

Air from the external environment is supplied to the compressor in order to pressurise it.

The pressurised air passes through a series of pre-mixing chambers which terminate in a converging portion and in each of which an injector feeds fuel which is mixed with the air so as to form an air/fuel mixture to be combusted.

The fuel is introduced into the combustion chamber and is ignited by means of suitable igniter plugs so as to produce combustion, which is aimed at causing an increase in temperature and pressure and therefore enthalpy of the gas.

At the same time, the compressor provides pressurised air which is made to pass both through the burners and through the linings of the combustion chamber so that the abovementioned pressurised air is available for fuelling combustion.

Subsequently, the high-temperature and high-pressure gas reaches, by means of suitable ducts, the different stages of the turbine, which converts the enthalpy of the gas into mechanical energy available for a user.

It is also known that, in order to obtain the maximum efficiency from a given gas turbine, in addition to other cycle parameters, the temperature of the gas must be as high as possible; however, the maximum temperature values which can be reached during use of the turbine are limited by the strength of the materials used and by the cooling techniques which can be applied.

The increase in the compression ratio and the combustion temperature have a synergic effect on the performance characteristics of the gas turbine cycle, be it of the single or combined type: manufacturers are aware that their competitiveness within the market depends on the ability to make progress in this connection.

These two parameters must be clearly defined in relation to the technology and materials which, for the sake of economic advantage, are to be used during design of the machine.

In general, the starting point for definition of the thermodynamic cycle of an industrial gas turbine is definition of the combustion temperature T³ (which is assumed to be realistically not very uniform) followed by selection of the materials and cooling techniques to be suitably provided. The object of maximising the enthalpy content of the gases at the turbine inlet, and hence the efficiency of the thermodynamic cycle, therefore involves the attainment of temperatures at the outlet of the combustion chamber which are increasingly higher, in keeping with the materials provided by the current technology.

According to the present state of the art, it is envisaged, for example, that the stator blades of the first expansion stages of a gas turbine are made by means of microfusion of typically nickel or cobalt-based superalloys, always in conjunction with cooling measures.

The following stages are also made by means of microfusion of superalloys, all cobalt or nickel-based materials with an excellent oxidation resistance and reasonable mechanical properties, at least up to temperatures of about 800° C.; in the case of higher temperatures suitable cooling is therefore required.

In view of the temperatures involved, the oxidation resistance and corrosion strength of these superalloys in the hot state would clearly be inadequate if cooling and screening of the surfaces with a film of cooling air were not envisaged.

The cooling techniques, no matter how sophisticated, would nevertheless no longer be able to ensure an adequate duration of the components if technologies for protecting the metal surfaces with the application of heat and anti-oxidant barriers had not been introduced. At present, the increase in the current performance characteristics is now sought after, rather than by using increasingly sophisticated basic materials for the blades, by means of the development of heat and anti-oxidation barriers and generally coatings or linings which offer an increasingly optimum performance. These protective barriers are applied using varied methods such as additional coatings on the surface of the components composed of a single body, imitating the geometrical morphology thereof.

These barriers are essentially surface coatings generally formed by means of plasma spray methods involving the application of homogeneous layers of a bond coat, followed by a surface lining, or top coat: these layers nowadays have an increasing thickness, with all the consequent behavioural problems associated with the superalloy body to which they are applied.

Furthermore, the development of heat barriers is also reaching its limits in terms of manufacturing and application technologies.

Basically it is noted that, during the use in industrial gas turbines with very high combustion temperatures, the components of the gas turbine have a low resistance to the high-temperature thermomechanical stresses.

It is therefore necessary to use large throughputs of cooling air which increase the load of the machine cycle, negatively affecting the efficiency and emissions.

The consequence of this is also the difficulty of developing cooling flows which are suitable for limiting the oxidation of the metal components used.

In practice, the increasingly greater efficient levels required result in an increase in the cycle temperatures which render the conventional constructional solutions unsuitable from the point of view of increasing and/or maintaining the working life of the components which are subject to high temperatures, or so-called hot components.

Also evident is the difficulty in restoring the damaged components, with a limited number of possible repair operations.

The object of the present invention is therefore that of overcoming the drawbacks mentioned above and in particular that of indicating a manufacturing method for obtaining high-temperature components for gas turbines which manage to withstand increasingly higher temperatures.

Another object of the present invention is that of providing high-temperature components for gas turbines which allow the attainment of very high compression ratios which cannot be achieved economically with the components known in the art.

Another object of the present invention is that of providing high-temperature components which require small throughputs of cooling fluid.

Another object of the present invention is that of indicating a manufacturing method for obtaining high-temperature components for gas turbines which are particularly reliable, easy to maintain and have a relatively low cost.

These and other objects according to the present invention are achieved by indicating a manufacturing method for obtaining high-temperature components for gas turbines as described in claim 1. Claim 3 also specifies how these high-temperature components for gas turbines are obtained. Further characteristic features of the invention are envisaged in the remaining claims.

The characteristic features and advantages of a manufacturing method for obtaining high-temperature components for gas turbines and the components thus obtained in accordance with the present invention will become clearer and more obvious from the following description provided by way of a non-limiting example, with reference to the accompanying schematic drawings in which:

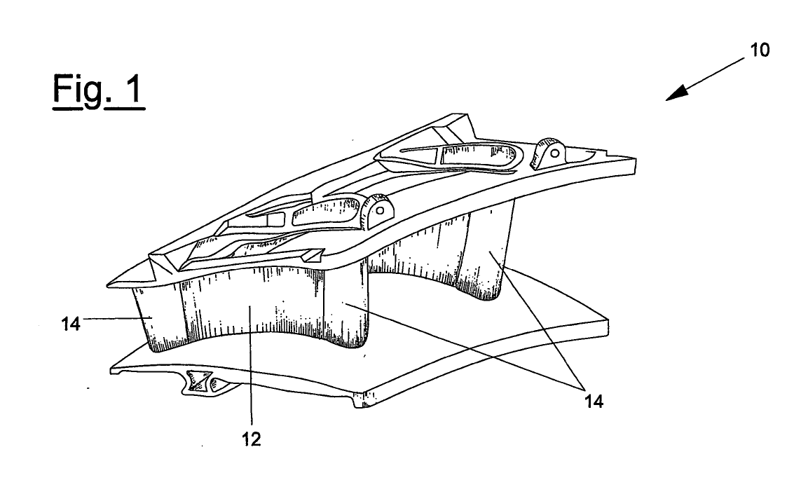

FIG. 1 is an axonometric view of a high-temperature component part for gas turbines, obtained in accordance with the manufacturing method of the present invention.

With reference to the Figure, this shows a part of a high-temperature stator component for gas turbines, denoted overall by 10.

According to the present invention, the manufacturing method for obtaining the component 10 for gas turbines comprises the manufacture of a main body 12 which is produced using the usual techniques of the known art and inside which at least one element or insert 14 of the modular type is incorporated.

According to the invention, these elements 14 have special mechanical properties which are suitably calibrated for the stresses typical of the point where insertion is envisaged.

Furthermore, these elements 14 are combined with the main body 12 using known fixing methods.

In the example according to FIG. 1, these elements 14 are arranged in inlet and outlet zones of each blade.

As a result it is thus possible to obtain an overall component having a particular resistance to high temperatures in the zones which are more directly affected by the high-temperature gaseous columns, maintaining optimum mechanical properties and a limited need for cooling flows in the body 12 of the component 10, which has a fundamentally structural role.

The difference between the materials used for the main body 12 and inserts 14, made possible by the manufacture of modular elements 14, also allows the use of materials which are the most appropriate not only from a technical point of view but also from the point of manufacturing economy.

The possibility of removing and replacing completely the damaged elements 14, while retaining those which are still fit for operation, also benefits considerably the maintenance and overhaul operations carried out during the working life.

It is clear from that stated that the present invention represents a technological leap from surface coatings generally produced by means of plasma spray methods with the application of homogeneous layers of a bond coat and top coat (said layers being nowadays of increasing thickness), to actual elements 14 performing the function of sacrificial elements and having properties and configurations which are specific for the point of the component 10 and type of operating conditions in which operation is envisaged.

The main result of the present invention is the possibility of achieving a robust design with the manufacture of components 10 for gas turbines having elements 14 made of materials resistant to high temperatures such as to allow a significant reduction in the cooling air, a significant increase in the working life and easy repair of the component after total/partial replacement of the elements 14.

The above description clearly demonstrates the characteristic features of the manufacturing method for obtaining high-temperature components for gas turbines and the components thus obtained, according to the present invention, as well as the advantages arising therefrom.

The following final considerations and comments are added here in order to define the abovementioned advantages with greater precision and clarity.

Firstly it is pointed out that, with the manufacturing method for obtaining high-temperature components for gas turbines according to the invention, it is possible to obtain components which are resistant to very high temperatures.

In this way very high compression ratios of the gas turbine are achieved, of the kind which cannot be obtained conveniently with the components known in the art, while ensuring the availability of very reliable parts at a relatively low cost.

Finally it is clear that the manufacturing method for obtaining high-temperature components for gas turbines as well as the resultant components, thus conceived, may be subject to modifications and variations all within the scope of the invention; moreover all the details may be replaced by technically equivalent elements. In practice the materials used, as well as the forms and dimensions, may be of any nature in accordance with the technical requirements. The scope of protection of the invention is therefore delimited by the accompanying claims.

1. Manufacturing method for obtaining high-temperature components (10) for gas turbines, characterized in that it comprises at least incorporation of an element or insert (14) in a main body (12) of said component (10), said element or insert (14) having mechanical properties able to withstand stresses to which said component (10) is subject in a zone where the said element or insert (14) is arranged.

2. Manufacturing method according to claim 1, characterized in that it envisages at least one fixing process for joining said element or insert (14) to said main body (12) of said component (10).

3. High-temperature component (10) for gas turbines, characterized in that it is obtained by incorporating at least one element or insert (14) in a main body (12) of said component (10), said element or insert (14) having mechanical properties able to withstand stresses to which said component (10) is subject in a zone where said element or insert (14) is arranged.

4. Component (10) according to claim 3, characterized in that said element or insert (14) is of the modular type.

5. Component (10) according to claim 3, characterized in that said element or insert (14) is arranged in an inlet zone of a blade.

6. Component (10) according to claim 3, characterized in that said element or insert (14) is arranged in an outlet zone of a blade.

7. Component (10) according to claim 3, characterized in that said element or insert (14) is made of a material which is more resistant to high temperatures than the material of said main body (12).
